(19) United States
(12) Patent Application Publication
(10) Pub. No.: US 2010/0150597 A1
(43) Pub. Date: Jun. 17, 2010

(54) FIXING APPARATUS AND IMAGE FORMING APPARATUS

(75) Inventors: Satoshi KINOUCHI, Tokyo (JP); Kazuhiko KIKUCHI, Kanagawa (JP); Toshihiro SONE, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/638,450

(22) Filed: Dec. 15, 2009

Related U.S. Application Data
(60) Provisional application No. 61/138,086, filed on Dec. 16, 2008.

(51) Int. Cl. G03G 15/20

(52) U.S. Cl. 399/69

(57) ABSTRACT

A center coil and side coils alternately operate at least once while a heat belt passes positions corresponding to the center coil and the side coils. A controller controls the operation time of the center coil and the operation time of the side coils according to comparison of detected temperature of a first temperature sensor and detected temperature of a second temperature sensor.

### CROSS-REFERENCE TO RELATED APPLICATION

This application is based upon and claims the benefit of priority from U.S. provisional application 61/138,086, filed Dec. 16, 2008, the entire contents of which are incorporated herein by reference.

### TECHNICAL FIELD

An embodiment disclosed herein relates to a fixing apparatus and an image forming apparatus configured t fix, on a paper sheet, a developer image formed on the paper sheet.

### BACKGROUND

An image forming apparatus reads an image from an original document, forms a developer image corresponding to the read image on a paper sheet, and fixes the developer image on the paper sheet with a fixing apparatus.

The fixing apparatus leads the paper sheet in between a rotating member such as a heat roller or a heat belt and a pressing member such as a press roller and applies heat and pressure to the paper sheet to thereby fix, on the paper sheet, the developer image on the paper sheet.

A center coil and two side coils for induction heating are provided near the rotating member. A high-frequency current is supplied to the center coil and the side coils, whereby high-frequency magnetic fields are generated from the center coil and the side coils. An eddy-current is generated in the rotating member by the high-frequency magnetic fields. The rotating member is heated by Joule heat based on the eddy-current.

An example of such a fixing apparatus of an induction heating type is disclosed in JP-A-2001-312178.

The center coil induction-heats substantially the center of the rotating member in an axial direction of the rotating member (a direction orthogonal to a rotating direction of the rotating member). The side coils induction-heat one end and the other end of the rotating member in the axial direction of the rotating member. The center coil and the side coils alternately operate for a predetermined time.

When a paper sheet of a small size passes between the rotating member and the heating member, the temperature at both the ends of the rotating member not set in contact with the paper sheet is higher than the temperature in the center of the rotating member set in contact with the paper sheet. If the temperature at both the ends of the rotating member rises higher than the temperature in the center, the hardness of an elastic member such as rubber forming both the ends of the rotating member falls earlier than the hardness of an elastic member such as rubber forming the center. Therefore, the durable life of the rotating member is reduced.

When a paper sheet of a full size passes between the rotating member and the pressing member immediately after the paper sheet of the small size passes between the rotating member and the pressing member, a developer on the paper sheet is offset to both the ends of the high-temperature rotating member. This may cause a fixing failure.

### SUMMARY

A fixing apparatus disclosed herein includes:

a rotating member configured to rotate;

a pressing member configured to be set in contact with the rotating member to rotate together with the rotating member and lead a fixing object in between the pressing member and the rotating member to press to the fixing object;

a first coil configured to excite eddy-current in a first area as a part of the rotating member in a direction orthogonal to a rotating direction of the rotating member;

a second coil configured to excite eddy-current in a second area on the rotating member different section from the first area;

a first temperature sensor configured to detect temperature T1 of the first area;

a second temperature sensor configured to detect temperature T2 of the second area;

a controller configured to control the first coil and the second coil to alternately operate at least once while the rotating member passes positions to face the first coil and the second coil, and configured to control operation time of the first coil and the second coil according to the temperature T1 and the temperature T2.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate presently embodiments of the invention, and together with the general description given above and the detailed description of the preferred embodiments given below, serve to explain the principles of the invention.

FIG. 1 is a diagram of the configuration of a fixing apparatus according to an embodiment of the present invention;

FIG. 2 is a diagram of the fixing apparatus shown in FIG. 1 viewed from a side;

FIG. 3 is a block diagram of a control circuit for an image forming apparatus according to the embodiment;

FIG. 4 is a block diagram of an electric circuit of the fixing apparatus according to the embodiment;

FIG. 5 is a flowchart for explaining actions of the embodiment;

FIG. 6 is a diagram of operation patterns of coils according to the embodiment;

FIG. 7 is a diagram of heated areas of a heat belt heated by the operation patterns shown in FIG. 6;

FIG. 8 is a diagram of other operation patterns of the coils according to the embodiment;

FIG. 9 is a diagram of heated areas of the heat belt heated by the operation patterns shown in FIG. 8;

FIG. 10 is a diagram of heated areas of the heat belt heated by still other operation patterns of the coils according to the embodiment; and

FIG. 11 is a diagram of heated areas of the heat belt heated by still other operation patterns of the coils according to the embodiment.

### DETAILED DESCRIPTION

An embodiment of the present invention is explained below with reference to the accompanying drawings.

An image forming apparatus according to the embodiment of the present invention includes a scanning unit (a scanning unit 33 explained below) configured to optically read an image of an original document, a process unit (a process unit 45 explained below) configured to form, on a paper sheet as a fixing object, a developer image corresponding to the image read by the scanning unit, and a fixing apparatus (a fixing apparatus 1 explained later) configured to fix, on the paper sheet developer image formed on the paper sheet by heating the image. The specific configuration of the image forming apparatus is described in patent application Ser. No. 10/602,920 filed earlier. Therefore, explanation of the configuration is omitted.

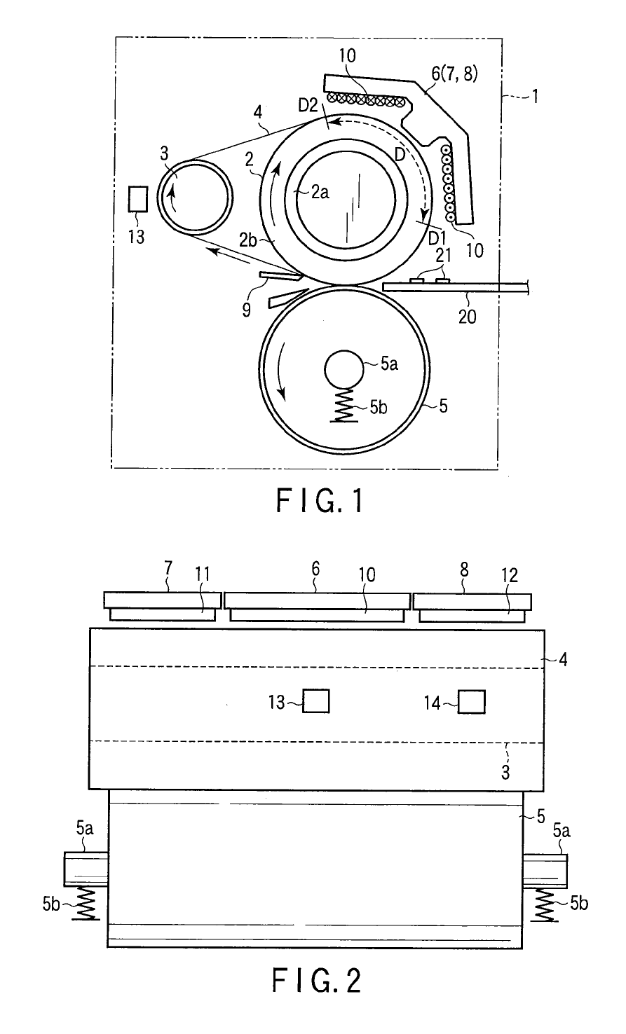

The configuration of the fixing apparatus is shown in FIGS. 1 and 2.

A fixing apparatus 1 includes a fixing roller 2, a tension roller 3, and a rotating member such as a heat belt 4 laid over between the fixing roller 2 and the tension roller 3. The heat belt 4 and a press roller 5 as a pressing member vertically nip a conveying path for a paper sheet 20 as a fixing object. The press roller 5 is set in contact with the surface (the outer circumferential surface) of the heat belt 4 in a pressed state to rotate together with the heat belt 4 and leads the paper sheet 20 in between the press roller 5 and the heat belt 4 to press to the paper sheet 20. The heat of the heat belt 4 is transmitted to the paper sheet 20, whereby a toner 21 on the paper sheet 20 is melted. The melted toner 21 is fixed on the paper sheet 20.

The fixing roller 2 has a diameter of 50 mm and includes a core bar 2a having thickness of 2 mm and a foamed rubber 2b having thickness of 5 mm. The fixing roller 2 receives power of a motor and rotates.

In the heat belt 4, a solid rubber layer having thickness of 200 μm and a release layer having thickness of 30 μm are formed in order on a metal conductive layer having thickness of 40 μm. The heat belt 4 has width larger than the width of the paper sheet 20 of a largest size. The heat belt 4 receives the rotation of the fixing roller 2 and rotates in an arrow direction in the figure. The metal conductive layer is nickel, stainless steel, aluminum, a composite material of stainless steel and aluminum, or the like. The solid rubber layer is silicon rubber. The release layer is a PFA tube. The press roller 5 includes a rotating shaft 5a and two springs 5b configured to apply upward bias force to the rotating shaft 5a.

A center core 6 and side cores 7 and 8 provide in positions corresponding to the heat belt 4 on the fixing roller 2. A center coil (a first coil) 10 and side coils (second coils) 11 and 12 respectively attach to the center core 6 and the side cores 7 and 8. The center coil 10 and the side coils 11 and 12 provide side by side in a direction orthogonal to the rotating direction of the heat belt 4.

The center coil 10 provides in a position corresponding to substantially the center of the heat belt 4 in the direction (an axial direction) orthogonal to the rotating direction of the heat belt 4. The side coil 11 provides in a position corresponding to one end of the heat belt 4 in the direction orthogonal to the rotating direction of the heat belt 4. The side coil 12 provides in a position corresponding to the other end of the heat belt 4 in the direction orthogonal to the rotating direction of the heat belt 4. The side coils 11 and 12 connect to each other to substantially form one coil.

High-frequency magnetic fields for induction heating generated from the center coil 10 and the side coils 11 and 12 are given to the heat belt 4, whereby an eddy-current is generated in the metal conductive layer of the heat belt 4. The metal conductive layer is heated by Joule heat based on the eddy-current. Specifically, the center coil 10 induction-heats substantially the center of the heat belt 4. The side coils 11 and 12 respectively induction-heat one end and the other end of the heat belt 4.

A blade 9 for peeling off the paper sheet 20 from the heat belt 4 and a first temperature sensor 13 and a second temperature sensor 14 of a thermopile type configured to detect the temperature on the surface of the heat belt 4 in a non-contact state provide around the heat belt 4.

The first temperature sensor 13 catches an infrared ray emitted from the heat belt 4 to thereby detect temperature T1 substantially in the center of the heat belt 4 in the direction (the axial direction) orthogonal to the rotating direction of the heat belt 4. The second temperature sensor 14 catches an infrared ray emitted from the heat belt 4 to thereby detect temperature T2 at the other end of the heat belt 4 in the direction (the axial direction) orthogonal to the rotating direction of the heat belt 4.

The temperature sensors 13 and 14 are not limited to temperature sensors of a non-contact type separated from the heat belt 4 and may be temperature sensors of a contact type set in contact with the surface of the heat belt 4.

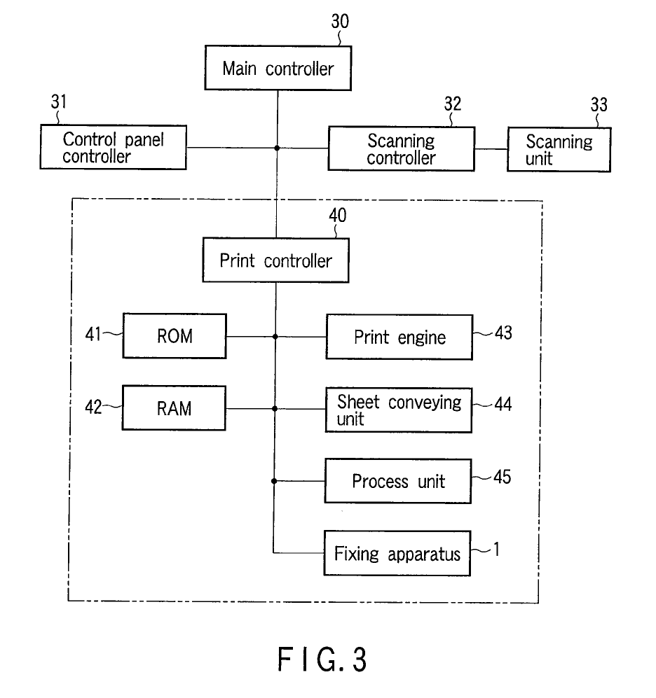

A control circuit for the image forming apparatus is shown in FIG. 3.

A control panel controller 31, a scanning controller 32, and a print controller 40 connect to a main controller 30.

The main controller 30 collectively controls the control panel controller 31, the scanning controller 32, and the print controller 40. The scanning controller 32 controls the scanning unit 33 configured to optically read an image of an original document.

A ROM 41 for control program storage, a RAM 42 for data storage, a print engine 43, a sheet conveying unit 44, a process unit 45, and the fixing apparatus 1 connect to the print controller 40. The print engine 43 emits a laser beam for forming, on a photoconductive drum of the process unit 45, the image read by the scanning unit 33. The sheet conveying unit 44 includes a conveying mechanism for the paper sheet 20 and a driving circuit for the conveying mechanism. The process unit 45 forms, on the surface of the photoconductive drum, an electrostatic latent image corresponding to the image read by the scanning unit 33 using the laser beam emitted from the print engine 43, develops the electrostatic latent image on the photoconductive drum with a developer, and transfers a developer image of the electrostatic latent image onto the paper sheet 20.

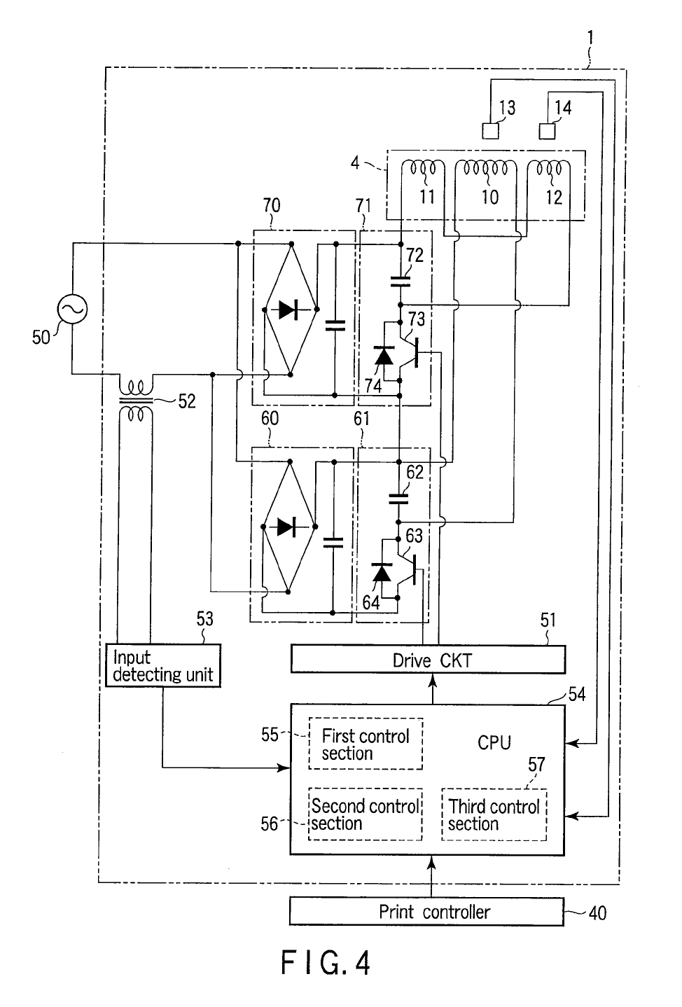

An electric circuit of the fixing apparatus 1 is shown in FIG. 4.

Rectifying circuits 60 and 70 connect to a commercial AC power supply 50. High-frequency generating circuits (also referred to as switching circuits) 61 and 71 respectively connect to output ends of the rectifying circuits 60 and 70.

The high-frequency generating circuit 61 includes a resonant capacitor 62 configured to form a resonant circuit together with the center coil 10, a switching element such as a transistor 63 configured to excite the resonant circuit, and a damper diode 64 connected in parallel to the transistor 63, and generates a high-frequency current with the transistor 63 is driven to be turned on and off by a driving circuit 51.

The high-frequency generating circuit 71 includes a resonant capacitor 72 configured to form a resonant circuit together with the side coils 11 and 12, a switching element such as a transistor 73 configured to excite the resonant circuit, and a damper diode 74 connected in parallel to the transistor 73, and generates a high-frequency current with the transistor 73 is driven to be turned on and off by a driving circuit 51.

The high-frequency currents generated by the high-frequency generating circuits 61 and 71 respectively supplies to the center coil 10 and the side coils 11 and 12, whereby high-frequency magnetic fields are generated from the center coil 10 and the side coils 11 and 12. The heat belt 4 is heated by the high-frequency magnetic fields. Both the power of the center coil 10 and the power of the side coils 11 and 12 can be adjusted in a range of 200 W to 1500 W.

A current transformer 52 connects to a current-carrying path between the commercial AC power supply 50 and the rectifying circuits 60 and 70. An input detecting unit 53 connects to an output end of the current transformer 52. The input detecting unit 53 detects an input current to the fixing apparatus 1. A result of the detection supplies to a CPU 54.

The temperature sensors 13 and 14, the print controller 40, and the driving circuit 51 connect to the CPU 54. The CPU 54 includes a first control section 55, a second control section 56, and a third control section 57.

The first control section 55 causes the center coil 10 and the side coils 11 and 12 to alternately operate at least once while the heat belt 4 passes the center coil 10 and the side coils 11 and 12.

The second control section 56 controls, according to comparison of the detected temperature T1 of the first temperature sensor 13 and the detected temperature T2 of the second temperature sensor 14, the operation time of the center coil 10 and the operation time of the side coils 11 and 12 by the first control section 55. Specifically, if a difference ΔT between the detected temperature T1 of the first temperature sensor 13 and the detected temperature T2 of the second temperature sensor 14 is equal to or smaller than a set value ΔT1, for example, 5° C., the second control section 56 sets the operation time of the center coil 10 and the operation time of the side coils 11 and 12 the same. If the difference ΔT is larger than the set value ΔT1 and the detected temperature T1 is higher than the detected temperature T2, the second control section 56 sets the operation time of the side coils 11 and 12 longer than the operation time of the center coil 10. If the difference ΔT is larger than the set value ΔT1 and the detected temperature T1 is equal to or lower than the detected temperature T2, the second control section 56 sets the operation time of the center coil 10 longer than the operation time of the side coils 11 and 12.

For example, thermopiles are used as the first temperature sensor 13 and the second temperature sensor 14. Thermal reactivity of the thermopiles is about 40 ms. The CPU 54 averages detected temperatures of the first temperature sensor 13 and the second temperature sensor 14 in time of 160 ms required by the heat belt 4 to pass positions corresponding to the center coil 10 and the side coils 11 and 12. Averaged values of the detected temperatures use as the detected temperatures T1 and T2.

If the detected temperature T1 of the first temperature sensor 13 exceeds fixing temperature, for example, 160° C., the third control section 57 reduces power of the center coil 10 and power of the side coils 11 and 12.

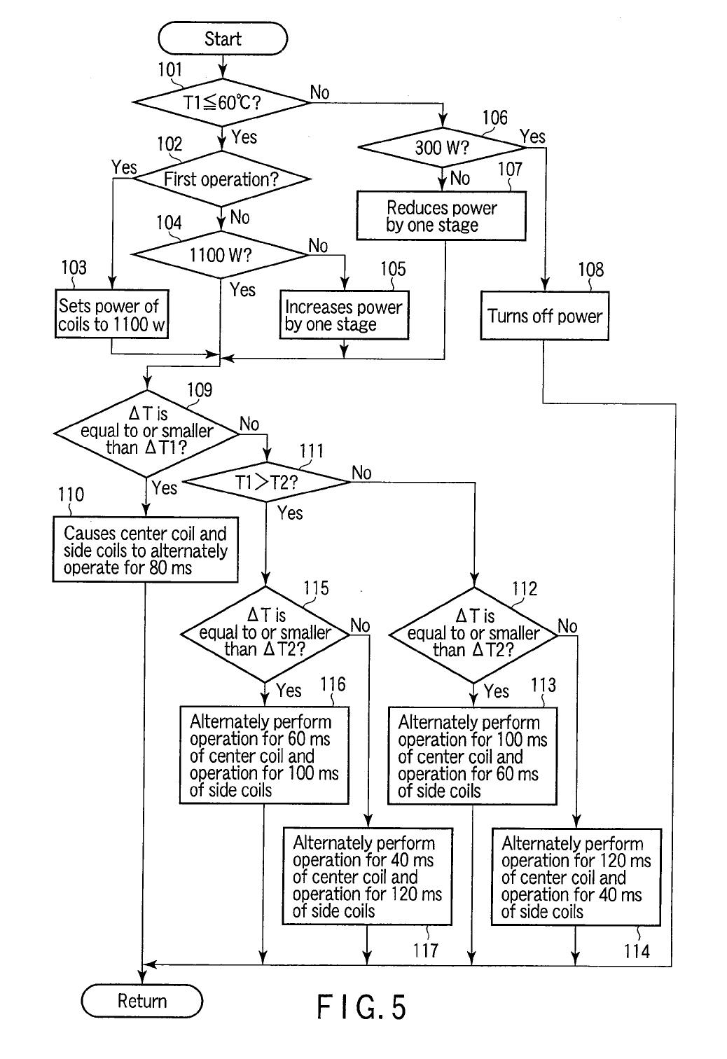

Actions are explained below with reference to a flowchart of FIG. 5.

The CPU 54 compares the detected temperature T1 of the first temperature sensor 13 with the fixing temperature 160° C. (Act 101). If the detected temperature T1 is equal to or lower than the fixing temperature 160° C. (YES in Act 101), the CPU 54 determines whether the present operation is first operation (Act 102).

If the present operation is the first operation (YES in Act 102), the CPU 54 sets to 1100 W of the power of the center coil 10 and the power of the side coils 11 and 12 (Act 103). If the present operation is not the first operation (NO in Act 102), the CPU 54 determines whether the power of the center coil 10 and the power of the side coils 11 and 12 reach 1100 W (Act 104).

If the power of the center coil 10 and the power of the side coils 11 and 12 do not reach 1100 W (NO in Act 104), the CPU 54 increases by one stage power of the center coil 10 and power of the side coils 11 and 12 (Act 105). The increase by one stage is repeated until the power of the center coil 10 and the power of the side coils 11 and 12 reach 1100 W after processing in Act 109 and subsequent acts explained later is executed.

If the detected temperature T1 of the first temperature sensor 13 exceeds the fixing temperature 160° C. (NO in Act 101) and if the power of the center coil 10 and the power of the side coils 11 and 12 do not fall to 300 W yet (NO in Act 106), the CPU 54 reduces by one stage power of the center coil 10 and power of the side coils 11 and 12 (Act 107). The reduction by one stage is repeated until the detected temperature T1 of the first temperature sensor 13 falls to the fixing temperature 160° C. after the processing in Act 109 and subsequent acts explained later is executed.

In this way, the CPU 54 feedback-controls the power of the center coil 10 and the power of the side coils 11 and 12 to adjust the detected temperature T1 of the first temperature sensor 13 to the fixing temperature 160° C.

If the power of the center coil 10 and the power of the side coils 11 and 12 fall to 300 W while the detected temperature T1 of the first temperature sensor 13 do not fall to the fixing temperature 160° C. (YES in Act 106), the CPU 54 turns off the power of the center coil 10 and the power of the side coils 11 and 12 under the determination that abnormality occurs (Act 108).

On the other hand, the CPU 54 determines whether the difference ΔT between the detected temperature T1 of the first temperature sensor 13 and the detected temperature T2 of the second temperature sensor 14 is equal to or smaller than the set temperature ΔT1, for example, 5° C. (Act 109). If the difference ΔT is equal to or smaller than 5° C. (YES in Act 109), the center coil 10 and the side coils 11 and 12 alternately operates for the same time, for example, 80 ms (Act 110).

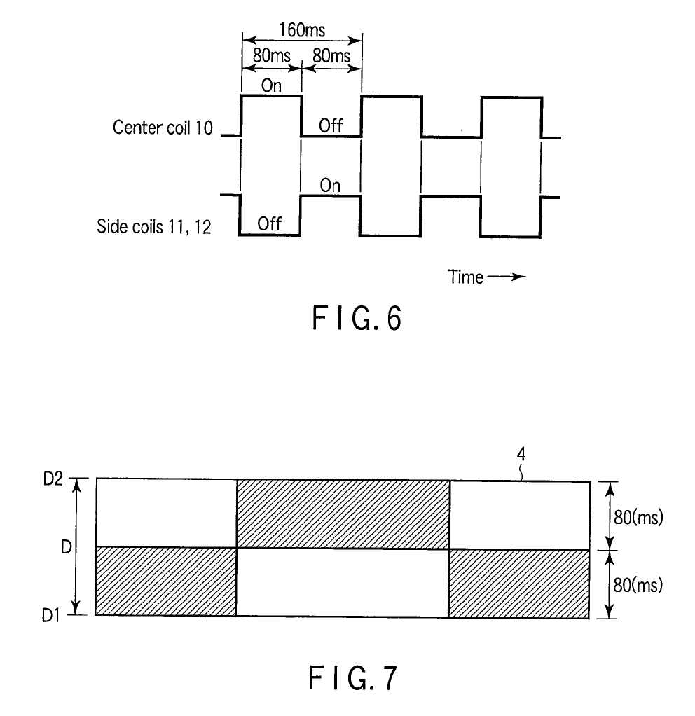

An area corresponding to the center coil 10 and the side coils 11 and 12 in the entire area in the rotating direction of the heat belt 4 is an area D from D1 to D2 shown in FIG. 1. Time until the area D gets past the positions corresponding to the center coil 10 and the side coils 11 and 12 according to the rotation of the heat belt 4 is 160 ms. During this period of 160 ms, the center coil 10 operates for 80 ms and then the side coils 11 and 12 operate for 80 ms. Operation patterns of the center coil 10 and the side coils 11 and 12 are shown in FIG. 6. Induction-heated areas corresponding to the area D of the heat belt 4 are indicated by hatching in FIG. 7.

When the operation for 80 ms of the center coil 10 and the operation for 80 ms of the side coils 11 and 12 are alternately repeated in this way, and when the paper sheets 20 continuously pass between the heat belt 4 and the press roller 5, the temperature T1 in the center of the heat belt 4 falls soon.

If the difference ΔT between the detected temperatures T1 and T2 is larger than 5° C. (NO in Act 109) and if the detected temperature T1 is equal to or lower than the detected temperature T2 (NO in Act 111), the CPU 54 sets the operation time of the center coil 10 longer than the operation time of the side coils 11 and 12. Specifically, if the difference ΔT is equal to or smaller than 10° C. as the set value ΔT2 (>ΔT1) (YES in Act 112), in the period of 160 ms, the center coil 10 having the lower temperature operates for 100 ms and then the side coils 11 and 12 having the higher temperature operate for 60 ms (Act 113).

If the difference ΔT is larger than 10° C. as the set value ΔT2 (NO in Act 112), in the period of 160 ms, the center coil 10 having the lower temperature operates for 120 ms and then the side coils 11 and 12 having the higher temperature operate for 40 ms (Act 114).

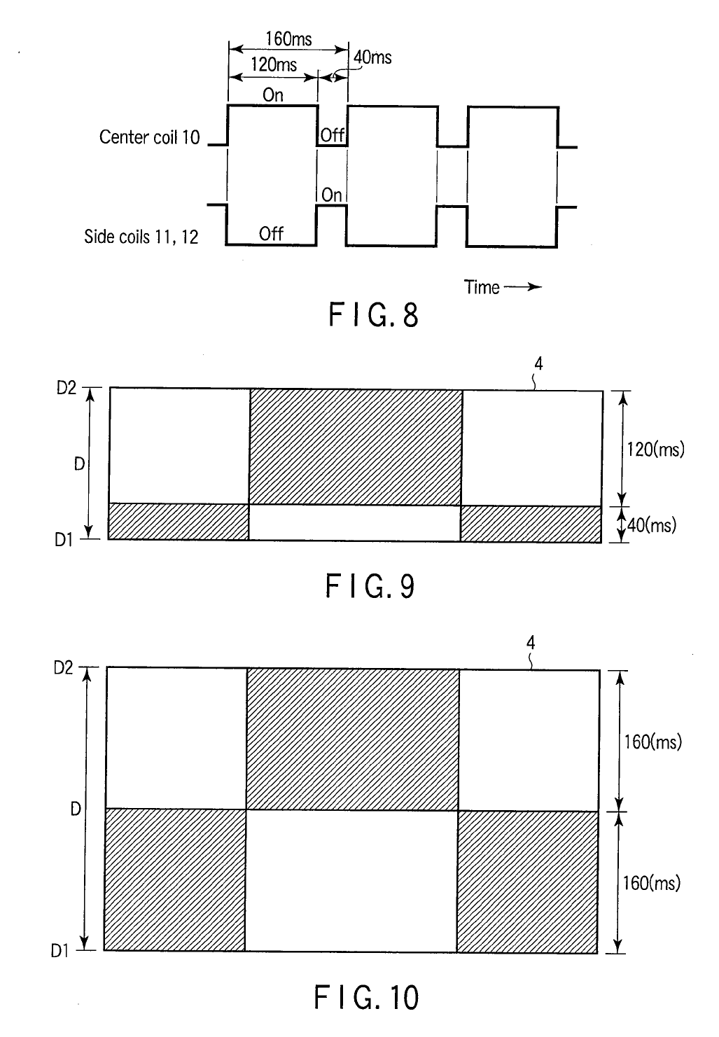

Operation patterns of the center coil 10 and the side coils 11 and 12 are shown in FIG. 8. Induction-heated areas corresponding to the area D of the heat belt 4 are indicated by hatching in FIG. 9.

If the difference ΔT between the detected temperatures T1 and T2 is larger than 5° C. (NO in Act 109) and if the detected temperature T1 is higher than the detected temperature T2 (YES in Act 111), the CPU 54 set the operation time of the side coils 11 and 12 longer than the operation time of the center coil 10. Specifically, if the difference ΔT is equal to or smaller than 10° C. as the set value ΔT2 (>ΔT1) (YES in Act 115), in the period of 160 ms, the center coil 10 having the higher temperature operates for 60 ms and then the side coils 11 and 12 having the lower temperature operate for 100 ms. If the difference ΔT is larger than 10° C. (NO in Act 115), in the period of 160 ms, the center coil 10 having the higher temperature operates for 40 ms and then the side coils 11 and 12 having the lower temperature operate for 120 ms (Act 117).

If the rotating speed of the heat belt 4 is low and the time until the area D gets past the positions corresponding to the center coil 10 and the side coils 11 and 12 is 380 ms, the center coil 10 and the side coils 11 and 12 alternately operate at least once in the period of 380 ms. An example of operation patterns of the center coil 10 and the side coils 11 and 12 is shown in FIG. 10.

As explained above, while the heat belt 4 passes the positions corresponding to the center coil 10 and the side coils 11 and 12, the center coil 10 and the side coils 11 and 12 alternately operate at least once. Therefore, the temperature at both the ends of the heat belt 4 does not rise higher than the temperature in the center of the heat belt 4. Moreover, the CPU 54 controls the operation time of the center coil 10 and the operation time of the side coils 11 and 12 according to the comparison of the detected temperature T1 of the first temperature sensor 13 and the detected temperature T2 of the second temperature sensor 14. Therefore, the temperature in the center and the temperature at both the ends of the heat belt 4 maintain uniform.

As a result, the hardness of the elastic member at both the ends in the axial direction of the fixing roller 2 set in contact with the heat belt 4 does not fall earlier than the hardness of the elastic member in the center in the axial direction of the fixing roller 2. This improves the durable life of the fixing roller 2 and the peripheral components thereof.

Even when the paper sheet 20 of a full size passes between the heat belt 4 and the press roller 5 immediately after the paper sheet 20 of a small size passes between the heat belt 4 and the press roller 5, the toner 21 on the paper sheet 20 of the full size does not offset to both the ends of the high-temperature heat belt 4. Therefore, satisfactory fixing can always be performed.

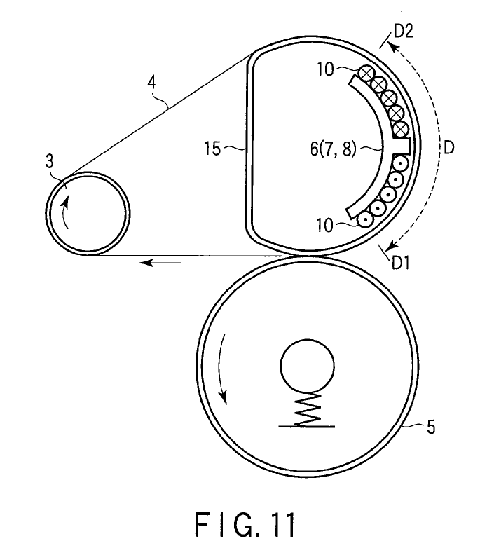

In the example explained in the embodiment, the center coil 10 and the side coils 11 and 12 are present on the outer side of the heat belt 4. However, the present invention can be carried out in the same manner when the center coil 10 and the side coils 11 and 12 are present on the inner side of the heat belt 4 as shown in FIG. 11. In this case, the center core 6 and the side cores 7 and 8 provide on the inner side of a guide member 15 formed by an elastic member. The center coil 10 and the side coils 11 and 12 attach to the center core 6 and the side cores 7 and 8. The heat belt 4 rotates while coming into slide contact with the outer circumferential surface of the guide member 15.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing apparatus comprising:
a rotating member configured to rotate;
a pressing member configured to be set in contact with the rotating member to rotate together with the rotating member and lead a fixing object in between the pressing member and the rotating member to press to the fixing object;
a first coil configured to excite eddy-current in a first area as a part of the rotating member in a direction orthogonal to a rotating direction of the rotating member;
a second coil configured to excite eddy-current in a second area on the rotating member different section from the first area;
a first temperature sensor configured to detect temperature T1 of the first area;
a second temperature sensor configured to detect temperature T2 of the second area;
a controller configured to control the first coil and the second coil to alternately operate at least once while the rotating member passes positions to face the first coil and the second coil, and configured to control operation time of the first coil and the second coil according to the temperature T1 and the temperature T2.

2. The apparatus of claim 1, wherein the first coil and the second coil are side by side in the direction orthogonal to the rotating direction of the rotating member.

3. The apparatus of claim 1, wherein the controller configured to set the operation time of the first coil and the operation time of the second coil the same if a difference ΔT between the temperature T1 and the temperature T2 is equal to or smaller than a set value ΔT1, configured to set the operation time of the second coil longer than the operation time of the first coil if the difference ΔT is larger than the set value ΔT1 and the temperature T1 is higher than the temperature T2, and configured to set the operation time of the first coil longer than the operation time of the second coil if the difference ΔT is larger than the set value ΔT1 and the temperature T1 is equal to or lower than the temperature T2.

4. The apparatus of claim 1, wherein the controller configured to reduce power of the first coil and power of the second coil if the temperature T1 exceeds a high-temperature side set value.

5. The apparatus of claim 1, further comprising:
a first high-frequency generating circuit configured to output a high-frequency current for causing the first coil to generate a high-frequency magnetic field for induction heating; and
a second high-frequency generating circuit configured to output a high-frequency current for causing the second coil to generate a high-frequency magnetic field for induction heating.

6. A fixing apparatus comprising:
a heat belt configured to rotate;
a press roller configured to be set in contact with the heat belt to rotate together with the heat belt and lead a paper sheet in between the press roller and the heat belt to press to the paper sheet;
a first coil configured to excite eddy-current in substantially a center of the heat belt in a direction orthogonal to a rotating direction of the heat belt;
a second coil configured to excite eddy-current in one end and the other end of the heat belt in the direction orthogonal to the rotating direction of the heat belt;
a first temperature sensor configured to detect temperature T1 of substantially the center of the heat belt in the direction orthogonal to the rotating direction of the heat belt;
a second temperature sensor configured to detect temperature T2 of one end or the other end of the heat belt in the direction orthogonal to the rotating direction of the heat belt;
a controller configured to control the first coil and the second coil to alternately operate at least once while the heat belt passes positions to face the first coil and the second coil, and configured to control operation time of the first coil and the second coil according to the temperature T1 and the temperature T2.

7. The apparatus of claim 6, wherein the first coil and the second coil are side by side in the direction orthogonal to the rotating direction of the heat belt.

8. The apparatus of claim 6, wherein the controller configured to set the operation time of the first coil and the operation time of the second coil the same if a difference ΔT between the temperature T1 and the temperature T2 is equal to or smaller than a set value ΔT1, controller configured to set the operation time of the second coil longer than the operation time of the first coil if the difference ΔT is larger than the set value ΔT1 and the temperature T1 is higher than the temperature T2, and controller configured to set the operation time of the first coil longer than the operation time of the second coil if the difference ΔT is larger than the set value ΔT1 and the temperature T1 is equal to or lower than the temperature T2.

9. The apparatus of claim 6, wherein the controller configured to reduce power of the first coil and power of the second coil if the temperature T1 exceeds a high-temperature side set value.

10. The apparatus of claim 6, further comprising:
a first high-frequency generating circuit configured to output a high-frequency current for causing the first coil to generate a high-frequency magnetic field for induction heating; and
a second high-frequency generating circuit configured to output a high-frequency current for causing the second coil to generate a high-frequency magnetic field for induction heating.

11. An image forming apparatus comprising:
a process unit configured to form an image on a paper sheet; and
a fixing apparatus configured to fix, on the paper sheet, the image forming on the paper sheet by heating the image, wherein
the fixing apparatus includes:
a heat belt configured to rotate;
a press roller configured to be set in contact with the heat belt to rotate together with the heat belt and lead a paper sheet in between the press roller and the heat belt to press to the paper sheet;
a first coil configured to excite eddy-current in substantially a center of the heat belt in a direction orthogonal to a rotating direction of the heat belt;
a second coil configured to excite eddy-current in one end and the other end of the heat belt in the direction orthogonal to the rotating direction of the heat belt;
a first temperature sensor configured to detect temperature T1 of substantially the center of the heat belt in the direction orthogonal to the rotating direction of the heat belt;
a second temperature sensor configured to detect temperature T2 of one end or the other end of the heat belt in the direction orthogonal to the rotating direction of the heat belt;
a controller configured to control the first coil and the second coil to alternately operate at least once while the heat belt passes positions to face the first coil and the second coil, and configured to control operation time of the first coil and the second coil according to the temperature T1 and the temperature T2.

12. The apparatus of claim 11, wherein the first coil and the second coil are side by side in the direction orthogonal to the rotating direction of the heat belt.

13. The apparatus of claim 11, wherein the controller configured to set the operation time of the first coil and the operation time of the second coil the same if a difference ΔT between the temperature T1 and the temperature T2 is equal to or smaller than a set value ΔT1, configured to set the operation time of the second coil longer than the operation time of the first coil if the difference ΔT is larger than the set value ΔT1 and the temperature T1 is higher than the temperature T2, and configured to set the operation time of the first coil longer than the operation time of the second coil if the difference ΔT is larger than the set value ΔT1 and the temperature T1 is equal to or lower than the temperature T2.

14. The apparatus of claim 11, wherein the controller configured to reduce power of the first coil and power of the second coil if the temperature T1 exceeds a high-temperature side set value.

15. The apparatus of claim 11, further comprising:
a first high-frequency generating circuit configured to output a high-frequency current for causing the first coil to generate a high-frequency magnetic field for induction heating; and
a second high-frequency generating circuit configured to output a high-frequency current for causing the second coil to generate a high-frequency magnetic field for induction heating.
